(19) United States
(12) Patent Application Publication
(10) Pub. No.: US 2022/0106475 A1
(43) Pub. Date: Apr. 7, 2022

(54) CONDUCTIVE WELDING MATERIAL AND METHOD FOR PRODUCING SAME

(71) Applicant: TOHO KASEI CO., LTD., Yamatokoriyama-shi, Nara (JP)

(72) Inventors: Hirotaka ITAMI, Yamatokoriyama-shi, Nara (JP); Hirokazu YAMAMOTO, Yamatokoriyama-shi, Nara (JP); Isamu NOGUCHI, Yamatokoriyama-shi, Nara (JP)

(21) Appl. No.: 16/967,804

(22) PCT Filed: Jan. 31, 2019
(86) PCT No.: PCT/JP2019/003357

§ 371 Date: Sep. 16, 2020

(30) Foreign Application Priority Data
Feb. 9, 2018 (JP) 2018-021654

(51) Int. Cl. C08L 27/18; B29C 43/02; C08K 3/04; B29C 43/00

(52) U.S. Cl. CPC C08L 27/18; B29C 43/02; B29K 2027/18; B29C 43/003; C08K 3/041

(57) ABSTRACT

Disclosed is a welding material made of a fluororesin composition in which carbon nano tubes are dispersed in a fluororesin, wherein the fluororesin composition includes 0.01 to 2.0% by mass of the carbon nano tubes.

### TECHNICAL FIELD

The present invention relates to a conductive welding material for a fluororesin and a method for producing the same, and more particularly to a conductive welding material for a fluororesin, which has excellent antistatic properties and exhibits excellent welding strength while preventing elution of impurities (metal ions, organic substances, etc.) and a method for producing the same.

### BACKGROUND ART

Fluororesins are often used as materials for components used to distribute corrosive fluids, pure water and chemical liquids in a semiconductor manufacturing apparatus, a pharmaceutical manufacturing apparatus and the like because of their excellent chemical resistance and contamination resistance.

However, since fluororesins are commonly classified as insulating materials, when the components produced by using the fluororesins come into contact with a fluid, electrostatic charge may occur due to friction.

It is known that conductive substances such as carbon black and iron powder are mixed with the fluororesins to impart conductivity to the fluororesins, and that the conductive substances comes into contact with the fluid, so that metallic ions, organic substances and the like are eluted into the fluid, leading to contamination of the fluid.

Patent Literature 1 discloses that a fluidic device provided with a fluid flow passage formed of a fluororesin material including 0.020% by weight or more 0.030% by weight or less of carbon nano tubes (hereinafter also referred to as “CNT”) having a fiber length of 50 μm or more and 150 μm or less and a fiber diameter of 5 nm or more and 20 nm or less is capable of suppressing electrostatic charge due to friction between the fluid flow passage and the fluid, and suppressing contamination due to contact between the fluid flow passage and the fluid (see Patent Literature 1, claim 1, [0008] to [0009], [0033], etc.).

### CITATION LIST

### Patent Literature

Patent Literature 1: JP 5987100 B1

### SUMMARY OF INVENTION

### Technical Problem

The fluid flow passage formed by the fluororesin material of JP 5987100 B1 is excellent in antistatic properties of the fluid and contamination resistance of the fluid. When a plurality of fluid flow passages are bonded to increase the length of the flow passage or to form a wider flow passage, and various shapes are formed, there is a problem such as treatment of the bonding part of the plurality of flow passages.

Since a liquid leaks in the bonding part if nothing is done, a material called a welding material is usually melted to seal and reinforce the bonding part so as to prevent liquid leakage. The fluororesin material may be used as a welding material (binder or sealer) as it is. However, there is a problem that, when the fluororesin is used as it is, antistatic properties are degraded because of its insufficient conductivity.

When a conductive substance such as carbon fiber is added to the fluororesin material so as to impart conductivity, it is usually necessary to add 5% by weight or more of the conductive substance so as to impart sufficient conductivity. However, such material usually has insufficient welding strength and inferior contamination resistance, and therefore it is not suited for use as the welding material.

### Solution to Problem

Thus, it is an object of the present invention to provide a conductive welding material for a fluororesin, which has excellent antistatic properties and exhibits excellent welding strength while preventing elution of impurities (metal ions, organic substances, etc.), and a method for producing the same.

The present inventors have intensively studied and found that, when using a fluororesin composition in which a specific amount of carbon nano tubes are dispersed in a fluororesin, it is possible to obtain a welding material which has excellent antistatic properties and exhibits excellent welding strength while preventing elution of impurities (metal ions, organic substances, etc.). They have also found that such welding material can be suitably used in various apparatuses such as a semiconductor manufacturing apparatus and a pharmaceutical manufacturing apparatus, and thus the present invention has been completed.

The present specification can include the following embodiments.

[1] A welding material made of a fluororesin composition in which carbon nano tubes are dispersed in a fluororesin, wherein the fluororesin composition comprises (or includes) 0.01 to 2.0% by mass of the carbon nano tubes.
[2] The welding material according to aforementioned 1, wherein the carbon nano tubes have an average length of 50 μm or more.
[3] The welding material according to aforementioned 1 or 2, which has a volume resistivity of 1×10⁻¹ to 1×10⁸ Ω·cm.
[4] The welding material according to any one of aforementioned 1 to 3, wherein the fluororesin comprises at least one selected from polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), ethylene/chlorotrifluoroethylene copolymer (ECTFE), polychlorotrifluoroethylene (PCTFE), polyvinylidene fluoride (PVDF) and polyvinyl fluoride (PVF).
[5] The welding material according to any one of aforementioned 1 to 4, wherein the fluororesin in the fluororesin composition has an average particle size of 500 μm or less.
[6] The welding material according to any one of aforementioned 1 to 5, which is used in a bonding part between a fluororesin and a fluororesin.
[7] A fluid treatment apparatus comprising (or including) the welding material according to any one of aforementioned 1 to 6 in a bonding part between a fluororesin and a fluororesin.
[8] A semiconductor manufacturing apparatus, a pharmaceutical manufacturing apparatus, a pharmaceutical delivery apparatus, a chemical manufacturing apparatus or a chemical delivery apparatus, each comprising (or including) the fluid treatment apparatus according to aforementioned 7.
[9] A method for producing the welding material according to any one of aforementioned 1 to 6, comprising (or including):

compression-molding a fluororesin composition in which carbon nano tubes are dispersed in a fluororesin.

[10] A method for producing the welding material according to any one of aforementioned 1 to 6, comprising (or including):

preparing a fluororesin composition in which carbon nano tubes are dispersed in a fluororesin selected from PTFE and modified PTFE;

placing the fluororesin composition in a mold, pressurizing and compressing the fluororesin composition to produce a pre-molded body;

calcining the pre-molded body at a temperature equal to or higher than a melting point of the fluororesin composition to produce a molded body; and

processing the molded body to produce a welding material.

[11] A method for producing the welding material according to any one of aforementioned 1 to 6, comprising (or including):

preparing a fluororesin composition in which carbon nano tubes are dispersed in a fluororesin other than PTFE and modified PTFE;

heating the fluororesin composition, pressurizing and compressing the fluororesin composition to obtain a molded body; and

processing the molded body to obtain a welding material.

### Effects of Invention

The welding material of according to the embodiment of the present invention has excellent antistatic properties and exhibits excellent welding strength while preventing elution of impurities (metal ions, organic substances, etc.). Therefore, it can be suitably used in a part (for example, a nozzle, a shower head, a spray nozzle, a rotating nozzle, a rotating washing nozzle, a liquid discharge part, a piping member, a liquid (chemical liquid) transfer tube, a liquid transfer joint, a lining piping, a lining tank and the like) through which a liquid passes of fluid treatment apparatuses such as a semiconductor manufacturing apparatus, a pharmaceutical manufacturing apparatus and a chemical manufacturing apparatus.

### BRIEF DESCRIPTION OF THE DRAWINGS

FIG. 1 shows an example of bonding between fluororesin components (a rectangular component and a cylindrical component).

FIG. 2 shows an example of bonding between fluororesin components (a rectangular component and a rectangular component).

FIG. 3 shows bonding between lining ends provided in a tank for holding a liquid.

FIG. 4 shows a measurement sample for measuring welding strength of a welding material.

FIG. 5 schematically shows a method for measuring welding strength of a welding material.

### DESCRIPTION OF EMBODIMENTS

The present invention provides a novel welding material, which is made of a fluororesin composition in which carbon nano tubes are dispersed in a fluororesin, wherein the fluororesin composition comprises (or includes) 0.01 to 2.0% by mass of the carbon nano tubes.

The welding material of the embodiment of the present invention is made of a fluororesin composition in which carbon nano tubes are dispersed in a fluororesin.

As used herein, the fluororesin composition includes a fluororesin and carbon nano tubes, and may include other ingredients as necessary, and is not particularly limited as long as the objective welding material of the present invention can be obtained.

As used herein, the “fluororesin” is a resin usually understood as a fluororesin, and is not particularly limited as long as the objective welding material of the present invention can be obtained.

Examples of the fluororesin include at least one selected from polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), ethylene/chlorotrifluoroethylene copolymer (ECTFE), polychlorotrifluoroethylene (PCTFE), polyvinylidene fluoride (PVDF) and polyvinyl fluoride (PVF).

The fluororesin is preferably polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), polychlorotrifluoroethylene (PCTFE) or polyvinylidene fluoride (PVDF), and more preferably modified polytetrafluoroethylene (modified PTFE), tetrafluoroethylene/perfluoroalkyl vinyl ether copolymer (PFA), tetrafluoroethylene/hexafluoropropylene copolymer (FEP) or polychlorotrifluoroethylene (PCTFE).

It is possible to use, as the fluororesin, commercially available products. Examples thereof include:

M-12 (trade name), M-11 (trade name) and POLYFLON PTFE-M (trade name) manufactured by Daikin Industries, Ltd. as polytetrafluoroethylene (PTFE);

M-111 (trade name), M-111 (trade name) and POLYFLON PTFE-M (trade name) manufactured by Daikin Industries, Ltd. as modified polytetrafluoroethylene (modified PTFE);

M-300PL (trade name), M-300H (trade name) and NEOFLON PCTFE (trade name) manufactured by Daikin Industries, Ltd. as polychlorotrifluoroethylene (PCTFE);

AP-230 (trade name), AP-210 (trade name) and NEOFLON PFA (trade name) manufactured by Daikin Industries, Ltd., and Fluon PFA (trade name) manufactured by AGC Inc. as tetrafluoroethylene/perfluoroalkyl vinyl ether (PFA); and the like.

These fluororesins can be used alone or in combination thereof.

In the embodiment of the present invention, the fluororesin of the fluororesin composition is in a form of particles, and has an average particle size of preferably 500 μm or less, more preferably 8 to 250 μm, still more preferably 10 to 50 μm, and particularly preferably 10 to 25 μm.

When the fluororesin of the fluororesin composition has an average particle size of 500 μm or less, the fluororesin and the carbon nano tubes can be more uniformly mixed, leading to a further improvement in conductivity.

As used herein, an average particle size of particles refers to an average particle size D₅₀ (median diameter which means a particle size at 50% of an integrated value in the particle size distribution determined by a laser diffraction scattering method) obtained by measuring the particle size distribution using a laser diffraction/scattering particle size distribution analyzer (“MT3300II”, manufactured by Nikkiso Co., Ltd.).

As used herein, the “carbon nano tube” is a substance usually understood as a carbon nano tube, and is not specifically limited as long as the objective welding material of the present invention can be obtained.

Examples of such carbon nano tube (also referred to as “CNTs”) include single-walled CNT, multi-walled CNT, double-layer CNT and the like. Commercially available products can be used as the carbon nano tube, for example, CNT-uni (trade name) series manufactured by TAIYO NIPPON SANSO CORPORATION can be used.

These CNTs may be used alone or in combination.

In the embodiment of the present invention, the carbon nano tube preferably has an average length of 50 μm or more, more preferably 70 to 250 μm, still more preferably 100 to 200 μm, and particularly preferably 150 to 200 μm.

When the CNT has an average length of 50 μm or more, it is preferable that the conductive path is easily connected, leading to more improvement in conductivity.

As used herein, the average length (or average fiber length) of the CNT refers to an average length obtainable from images taken by SEM, as described in detail in Examples. In other words, a portion of the welding material is heated to 300° C. to 600° C. to be asked, thus obtaining a residue (samples for SEM imaging). SEM images of the residue are taken. The length of each carbon nano tube in the SEM images is determined by image processing. An average of the lengths obtainable by the image processing is determined by calculation, and the average is regarded as the average length of the CNT.

In the embodiment of the present invention, the fluororesin composition includes 0.01 to 2.0% by mass, preferably 0.04 to 1.5% by mass, more preferably 0.05 to 1.0% by mass, and particularly preferably 0.05 to 0.5% by mass, of the carbon nano tube based on the fluororesin composition (100% by mass).

When the fluororesin composition includes 0.05 to 0.5% by mass of the carbon nano tube, it is preferable that it is an amount enough to form a conductive path, leading to more improvement in conductivity.

The welding material of the embodiment of the present invention preferably has a volume resistivity of 1×10⁻¹ to 1×10⁸ Ω·cm, more preferably, 1×10° to 1×10⁵ Ω·cm, and particularly preferably 1×10¹ to 1×10³ Ω·cm.

The measurements of the volume resistivity is mentioned in Examples.

With respect to the welding material of according to the embodiment of the present invention, regarding the contamination resistance evaluated by a method mentioned in Examples herein, amounts of Al, Cr, Cu, Fe, Ni and Zn detected are preferably less than 5 ppb, amounts of Al, Cr, Cu, Fe, Ni, Zn, Ca, K and Na detected are more preferably less than 5 ppb, and amounts of all metals eluted are particularly preferably less than 5 ppb.

An amount of the total organic carbon eluted is preferably less than 50 ppb, more preferably less than 40 ppb, and still more preferably less than 30 ppb.

The welding material of the embodiment of the present invention can have various shapes and dimensions depending on an intended application, and there is no particular limitation on shape and dimension as long as the objective welding material of the present invention can be obtained.

The shape of the welding material can be appropriately selected and, for example, rod shape, granular shape, spherical shape, lump shape, line shape, plate shape and the like can be appropriately selected in accordance with a welding target part (bonding part).

The dimension of the welding material can be appropriately selected considering the welding target part and the corresponding shape of the welding material.

For example, the welding material preferably has a rod shape having a circular or triangular cross section with a diameter of 2 to 5 mm. The fluororesin of the welding material preferably includes PFA.

The welding material according to the embodiment of the present invention may be produced using any method as long as the objective welding material of the present invention can be obtained.

The welding material of the embodiment of the present invention is preferably produced by a production method including compression-molding a fluororesin composition in which carbon nano tubes are dispersed in a fluororesin.

In the method for producing the welding material according to the embodiment of the present invention, the compression-molding method can partially vary depending on the fluororesin included in the welding material. The method for producing a welding material for PTFE and modified PTFE can be partially different from the method for producing a welding material for other fluororesins (for example, PFA, FEP, ETFE, ECTFE, PCTFE, PVDF and PVF).

The method for producing a welding material for PTFE and modified PTFE includes:

preparing a fluororesin composition in which carbon nano tubes are dispersed in a fluororesin (preferably particulate fluororesin);

(after performing an appropriate pre-treatment (pre-drying, granulation, etc.) as necessary) placing the fluororesin composition in a mold, pressurizing under a pressure of preferably 0.1 to 100 MPa, more preferably 1 to 80 MPa, and still more preferably 5 to 50 MPa, and compressing the fluororesin composition to produce a pre-molded body;

calcining the pre-molded body at a temperature equal to or higher than a melting point (temperature of preferably 345 to 400° C., and more preferably 360 to 390° C.) of the fluororesin composition for preferably 2 hours or more to produce a molded body; and

processing (preferably cutting) the molded body to produce a welding material.

The method for producing a welding material for fluororesins other than PTFE and modified PTFE (for example, PFA, FEP, ETFE, ECTFE, PCTFE, PVDF and PVF) includes:

preparing a fluororesin composition in which carbon nano tubes are dispersed in a fluororesin (preferably particulate fluororesin);

placing the fluororesin composition in a mold, and after performing an appropriate pre-treatment (pre-drying, etc.) as necessary, heating, for example, at a temperature of 150 to 400° C. for 1 to 5 hours, compressing the fluororesin composition under a pressure, for example, 0.1 to 100 MPa (preferably 1 to 80 MPa, and more preferably 5 to 50 MPa) to obtain a pre-molded body; and

processing (preferably cutting) the molded body to obtain a welding material.

The welding material according to the embodiment of the present invention can be used so as to bond a fluororesin (wherein the fluororesin includes a fluororesin component and a fluororesin molded body), and preferably to bond fluororesins with each other.

The present invention provides a welding material to be used in a bonding part of a fluororesin (wherein the fluororesin includes a fluororesin component and a fluororesin molded body), and preferably to be used in a bonding part between fluororesins.

There is no particular limitation on the part of use as long as the objective welding material of the present invention can be used. For example, the welding material can be suitably used if the part is a part where a fluororesin is bonded and a fluid is in contact with the bonding part. More specific examples thereof include a nozzle, a shower head, a spray nozzle, a rotating nozzle, a rotating washing nozzle, a liquid discharge part, a piping member, a liquid transfer tube, a liquid transfer joint, a lining piping, a lining tank and the like.

There is no particular limitation on a form of the bonding part as long as the welding material according to the embodiment of the present invention can be used. Examples of the form of the bonding part include face-to-face bonding, face-to-line bonding, face-to-point bonding, line-to-line bonding, line-to-point bonding, point-to-point bonding and the like.

There is no particular limitation on the fluororesin molded body and the fluororesin component as long as they are molded body and component produced using the fluororesin and can be bonded using the welding material according to the embodiment of the present invention. Examples thereof include sheets, films, plates, rods, bars, chunks, lumps, ducts, pipes and tubes, and processed products produced by the following methods (for example, cutting, skiving, drawing, blowing, injection molding, vacuum casting, 3D printing, 3D modeling, etc.)

The present invention provides a fluid treatment apparatus including the welding material according to the embodiment of the present invention in a welding part. As used herein, there is no particular limitation on the “treatment” as long as it is a treatment relating to a fluid. Examples thereof include storage, keeping, heating, pressurizing, cooling, stirring, mixing, filtration, extraction, separation, and combinations thereof.

The present invention also provides various apparatuses including such fluid treatment apparatus, for example, a semiconductor manufacturing apparatus, a pharmaceutical (or pharmaceutical agent) manufacturing apparatus, a pharmaceutical delivery apparatus, a chemical (or chemical agent) manufacturing apparatus and a chemical delivery apparatus.

The welding material of according to the embodiment of the present invention will be further described with reference to the accompanying drawings.

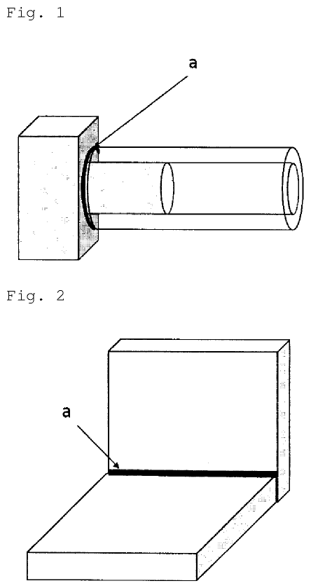

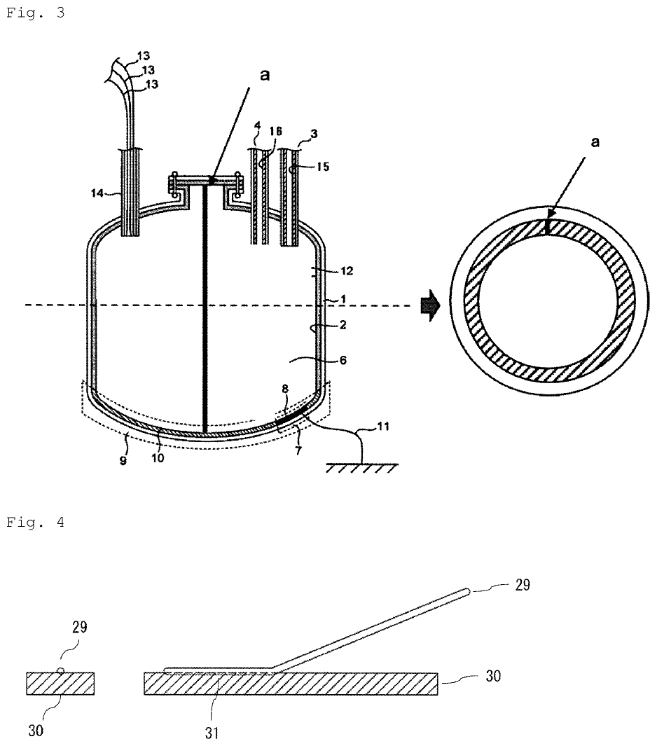

FIGS. 1 and 2 show examples of bonding between fluororesin components.

FIG. 1 schematically shows bonding between a rectangular or block-shaped fluororesin component with a cylindrical fluororesin component. The bonding part is melted and welded, and the welding material according to the embodiment of the present invention can be used. The bonding surface in FIG. 1 is donut-shaped and the welding material can be used for the donut-shaped bonding surface between the components, and the outer and/or inner periphery of the doughnut-shaped bonding surface. The welding material can be used to close a gap which may occur at the bonding part.

When both the rectangular fluororesin component and the cylindrical fluororesin component have no conductivity, it is possible to prevent electrostatic charge of a liquid in contact with the welding part and to remove electrostatic charge by grounding the welding material according to the embodiment of the present invention. When either the rectangular fluororesin component or the cylindrical fluororesin component has conductivity, it is possible to ground from either the rectangular fluororesin component or the cylindrical fluororesin component. The conductive fluororesin molded body is preferably made of a fluororesin composition in which carbon nano tubes are dispersed in a fluororesin.

FIG. 2 schematically shows bonding between a rectangular fluororesin component and a rectangular fluororesin component. The bonding part is melted and welded, and the welding material according to the embodiment of the present invention can be used in that case. The bonding surface in FIG. 2 has a rectangular shape, and the welding material can be used for the rectangular bonding surface between the components and/or the outer periphery of the rectangular bonding surface. The welding material can be used to close a gap which may occur at the bonding part.

When both the rectangular fluororesin component and the rectangular fluororesin component have no conductivity, it is possible to prevent electrostatic charge of a liquid in contact with the welding part and to remove electrostatic charge by grounding the welding material according to the embodiment of the present invention. When either the rectangular fluororesin component or the cylindrical fluororesin component has conductivity, it is possible to ground from either the rectangular fluororesin component or the cylindrical fluororesin component.

While face-to-face bonding has been illustrated as the bonding part, there is no limitation on the form of the bonding part as long as the welding material according to the embodiment of the present invention can be used. Examples of the bonding part include face-to-face bonding, face-to-line bonding, face-to-point bonding, line-to-line bonding, line-to-point bonding, point-to-point bonding and the like.

FIG. 3 shows, as a more specific apparatus, a tank for holding a liquid.

FIG. 3 schematically shows a tank provided with a fluororesin lining sheet on an inner surface. The tank comprises an outer tank can 1, a lining layer 2 provided on the inner surface of the outer tank can 1, a liquid introduction pipe 3 for introducing a liquid into the tank, and a liquid outflow pipe 4 for taking out the liquid outside the tank, and the liquid (not shown) can be stored in the tank. The lining sheet is preferably made of a fluororesin composition in which carbon nano tubes are dispersed in a fluororesin so as to obtain antistatic properties and contamination resistance by the lining sheet for the liquid in the tank.

The lining layer 2 provided on the inner surface of the tank outer can 1 is bonded between two opposing ends. In other words, there is a seam (a) between the two ends, which can create a gap (see the right side of FIG. 3). The welding material according to the embodiment of the present invention is used to close this gap, thus making it possible to prevent liquid leakage and to prevent antistatic charge and contamination by a metal.

### EXAMPLES

The present invention will be more specifically described in detail by way of Examples. It should be noted, however, each of these Examples is merely an embodiment of the present invention and the present invention is in no way limited thereto.

Components used in these Examples are shown below.

### (A) Fluororesin

(A1) Tetrafluoroethylene/perfluoroalkyl vinyl ether (Fluon PFA (trade name) manufactured by AGC Inc. (also referred to as “(A1) PFA”)

(A2) Modified polytetrafluoroethylene (POLYFLON PTFE-M (trade name) manufactured by Daikin Industries, Ltd.) (also referred to as “(A2) modified PTFE”)

### (B) Carbon Nano Tube

(B1) Carbon nano tube (average fiber length: about 150 μm, CNT-uni (trade name) manufactured by TAIYO NIPPON SANSO CORPORATION) (also referred to as “(B1) CNT”)

(B2) Carbon nano tube (average fiber length: about 400 μm, CNT-uni (trade name) manufactured by TAIYO NIPPON SANSO CORPORATION) (also referred to as “(B2) CNT”)

(B3) Carbon nano tube (average fiber length: about 90 μm, CNT-uni (trade name) manufactured by TAIYO NIPPON SANSO CORPORATION) (also referred to as “(B3) CNT”)

(B4)′ Carbon nano tube (average fiber length: about 30 μm, CNT-uni (trade name) manufactured by TAIYO NIPPON SANSO CORPORATION) (also referred to as “(B4)′ CNT”)

Carbon Black-Containing Fluororesin

(C1) Conductive PFA (AP-230ASL (trade name) manufactured by Daikin Industries, Ltd.)

### Example 1

A tetrafluoroethylene/perfluoroalkyl vinyl ether copolymer (PFA) (A1) was milled (or powdered) using a grinder and then classified by a vibrating screening machine to prepare PFA particles (A1). Using a laser diffraction-scattering particle size distribution analyzer (“MT3300II” manufactured by Nikkiso Co., Ltd.), the particle size distribution of the PFA particles (A1) was measured to obtain an average particle size (D₅₀) of the PFA particles (A1). The average particle size (D₅₀) of the PFA particles (A1) was 121.7 μm.

To 500 g of a carbon nano tube (B1) dispersion containing water as a solvent (dispersant: 0.15% by mass, carbon nano tube (B1): 0.1% by mass), 3,500 g of ethanol was added to dilute the carbon nano tube dispersion. Furthermore, 1,000 g of the PFA particles (A1) were added to prepare a mixed slurry.

The mixed slurry was fed into a pressure-resistant vessel and liquefied carbon dioxide was fed at a feeding rate of 0.03 g/minute relative to 1 mg of the dispersant contained in the mixed slurry in the pressure-resistant vessel, and then the pressure and the temperature were raised until the pressure inside the pressure-resistant vessel became 20 MPa and the temperature became 50° C. While holding the pressure and temperature for 3 hours, the carbon dioxide was discharged from the pressure-resistant vessel together with the dispersant and the solvents (water, ethanol) dissolved in the carbon dioxide.

The pressure and the temperature in the pressure-resistant vessel were respectively reduced to atmospheric pressure and normal temperature to remove the carbon dioxide in the pressure-resistant vessel, thus obtaining a PFA (A1) composition containing 0.1% by mass of the carbon nano tubes (B1).

Using a compression-molding method, the PFA (A1) composition was molded to obtain a PFA molded body. In other words, the PFA (A1) composition was placed in a mold and an appropriate pre-treatment (pre-drying, etc.) was performed as necessary. After heating the PFA (A1) composition at a temperature of 300° C. or higher for 2 hours or more, and then the PFA composition was cooled to normal temperature while compressing under a pressure of 5 MPa or more to obtain a PFA (A1) molded body.

The PFA (A1) molded body was subjected to cutting to obtain a welding material of Example 1 as a rod-shaped molded body. The welding material of Example 1 had a diameter (outer diameter) of about 5 mm and a length of about 200 mm.

### Example 2

Using a method similar to the method mentioned in Example 1, except that the content of the carbon nano tubes (B1) was changed to 0.05% by mass, a welding material of Example 2 was produced.

### Example 3

Using a method similar to the method mentioned in Example 1, except that the carbon nano tubes (B1) were changed to carbon nano tubes (B2), a welding material of Example 3 was produced.

### Example 4

Using a method similar to the method mentioned in Example 1, except that the carbon nano tubes (B1) were changed to carbon nano tubes (B3), a welding material of Example 4 was produced.

### Example 5

Modified polytetrafluoroethylene (modified PTFE) (A2) is commercially available in a granular form and has an average particle size (D₅₀) of 19.6 μm. Using a method similar to the method mentioned in Example 1, the average particle size (D₅₀) of the modified PTFE particles (A2) was measured.

Using a method similar to the method mentioned in Example 1, except that the PFA particles (A1) were changed to the modified PTFE particles (A2), a modified PTFE (A2) composition containing 0.1% by mass of carbon nano tubes (B1) were obtained.

Using a compression molding method, the modified PTFE composition (A2) was molded to obtain a modified PTFE molded body. In other words, the modified PTFE composition (A2) was subjected to an appropriate pre-treatment (pre-drying, etc.) if necessary, and then a given amount of the modified PTFE composition (A2) was uniformly filled into a mold. The modified PTFE composition (A2) was compressed by pressurizing under 15 MPa and holding for a given period of time to obtain a modified PTFE pre-molded body (A2). The modified PTFE pre-molded body (A2) was removed from the mold, calcined in a hot air circulation type electric furnace set at 345° C. or higher for 2 hours or more, slowly cooled and then removed from the electric furnace to obtain a modified PTFE molded body (A2). The modified PTFE molded body (A2) was subjected to cutting to obtain a welding material of Example 5 as a rod-shaped molded body. The welding material of Example 5 had a diameter (outer diameter) of about 5 mm and a length of about 200 mm.

### Comparative Example 1

Using a method similar to the method mentioned in Example 1, except that the carbon nano tubes (B1) were changed to carbon nano tubes (B4)′, a welding material of Comparative Example 1 was produced.

### Comparative Example 2

A conductive PFA (carbon black: 8% by mass) composition (C1) is commercially available in a pellet form.

Using a method similar to the method mentioned in Example 1, except that the PFA particles (A1) were changed to the conductive PFA (C1), a welding material of Comparative Example 2 was produced.

<Average Fiber Length>

Using SEM (VE-9800 (trade name) manufactured by KEYENCE CORPORATION), images of a welding material were taken and an average fiber length of carbon nano tubes included in the welding material was evaluated. A portion of the welding material was ashed by an asking method to fabricate a sample for SEM imaging. In other words, a portion of the welding material was heated to 300° C. to 600° C. to be ashed, thus obtaining a residue. Using the residue as a sample for imaging, SEM (scanning electron microscope) observation was performed. Each fiber length of fibers of each carbon nano tube included in the images was determined by image processing, and then the average of the fiber lengths was determined by calculation. The results are shown in Table 1.

### <Conductivity>

Using a method similar to the method in the above-mentioned compression molding method, specimens measuring φ10×10 mm were prepared for the respective Examples and Comparative Examples and used as samples for measuring the volume resistivity.

Using a resistivity meter (“Loresta” or “Hiresta” manufactured by Mitsubishi Chemical Analytech Co., Ltd.), the volume resistivity was measured in accordance with JIS K6911.

The evaluation criteria for conductivity are as follows.

A: The volume resistivity is 1×10³ Ω·cm or less.

B: The volume resistivity is more than 1×10³ Ω·cm and 1×10⁵ Ω·cm or less.

C: The volume resistivity is more than 1×10⁵ Ω·cm and 1×10⁸ Ω·cm or less.

D: The volume resistivity is more than 1×10⁸ Ω·cm.

### <Contamination Resistance>

Measurement of Amount of Metal Eluted from Welding Material

Degree (or level) of metal contamination in the welding material was evaluated by measuring each amount of metal eluted of each 17 metallic elements (Li, Na, Mg, Al, K, Ca, Ti, Cr, Mn, Fe, Co, Ni, Cu, Zn, Ag, Cd and Pb) using an ICP mass spectrometer (“ELAN DRCII” manufactured by PerkinElmer, Inc.).

Specimens measuring 10 mm×20 mm×50 mm were cut out from the sintered molded body obtained by compression molding. Each of the specimens was immersed in 0.5 L of 3.6% hydrochloric acid (EL-UM grade manufactured by Kanto Chemical Co., Inc.) for about 1 hour, and then washed by sprinkling and running ultrapure water (specific resistance value: ≥18.0 MΩ·cm). Furthermore, the entire specimen was immersed in 0.1 L of 3.6% hydrochloric acid and then stored in room temperature environment for 24 hours and 168 hours. After a lapse of the specified time, the entire amount of the immersion solution was collected (by collecting the entire amount of the immersion hydrochloric acid) and then the concentration of metal impurities in the immersion solution was analyzed. Three specimens were prepared and a maximum value thereof was regarded as the detection amount.

The evaluation criteria for conductivity are as follows.

A: The amounts of all metal detected are less than 5 ppb.

B: The amounts of Al, Cr, Cu, Fe, Ni, Zn, Ca, K and Na detected are less than 5 ppb.

C: The amounts of Al, Cr, Cu, Fe, Ni and Zn detected are less than 5 ppb.

D: The amount of any one of Al, Cr, Cu, Fe, Ni and Zn is 5 ppb or more.

The results are shown in Table 1.

Measurement of Carbon Loss from Welding Material

Degree of carbon nano tubes removed from the welding material was evaluated by measuring a total organic carbon (TOC) using a total organic carbon analyzer (“TOCvwp” manufactured by Shimadzu Corporation). Specifically, each of specimens measuring 10 mm×20 mm×50 mm cut out from the sintered molded body obtained by compression molding was immersed in 0.5 L of 3.6% hydrochloric acid (EL-UM grade manufactured by Kanto Chemical Co., Inc.) for about 1 hour. After immersion for 1 hour, each specimen was washed by sprinkling and running ultrapure water (specific resistance value: ≥18.0 MΩ·cm). Furthermore, the entire specimen was immersed in ultrapure water and then stored in room temperature environment for 24 hours and 168 hours. After lapse of the specified time, the entire amount of the immersion solution was collected (by collecting the entire amount of the immersion ultrapure water) and then the whole organic carbon analysis of the immersion solution was performed. Three specimens were prepared and a maximum value thereof was regarded as the detection amount.

The evaluation criteria for carbon loss are as follows.

B: The amount of total organic carbon detected is less than 50 ppb.

D: The amount of total organic carbon detected is 50 ppb or more.

### <Measurement of Welding Strength of Welding Material>

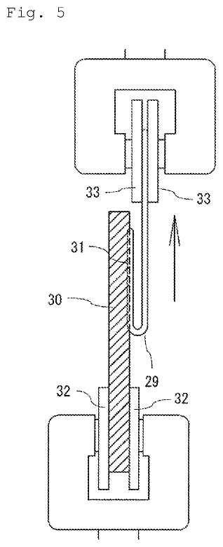

Weldability was evaluated based on welding strength of the welding material. The welding strength of the welding material was measured in accordance with JIS K7161. Specimens measuring 10 mm in thick, 30 mm in wide and 100 mm in length were prepared from a molded body of modified PTFE, followed by cutting to form a V-groove having a length of 50 mm and a depth of about 1 mm. Using a hot air welding machine, each of the welding materials of Examples 1 to 5 and Comparative Examples 1 to 2 was welded to the groove so that the length of the portion to be fused became 50 mm to fabricate specimens for measuring the welding strength as shown in FIG. 4. Next, as shown in FIG. 5, the specimen for measuring the welding strength was set in a tensile testing machine so that the folded portion of the fused welding material faces the lower side, and then the portion, which remains without being fused, of the welding material was set in the upper chuck of the machine. Using a tensile testing machine (“TENSILON universal material testing machine” manufactured by A&D Company, Limited), a tensile test was performed at a rate of 10 mm/min. The maximum stress was measured and regarded as the welding strength.

The evaluation criteria for welding strength are as follows.

A: The welding strength is 10 MPa or more when the specimen is made of modified PTFE.

B: The welding strength is 7 MPa or more and less than 10 MPa when the specimen is made of modified PTFE.

C: The welding strength is 4 MPa or more and less than 7 MPa when the specimen is made of modified PTFE.

D: The welding strength is less than 4 MPa when the specimen is made of modified PTFE.

TABLE 1

| | | | | | | Comparative | |
|---|---|---|---|---|---|---|---|
| | Example | | | | | Example | |
| | 1 | 2 | 3 | 4 | 5 | 1 | 2 |
| (A) | | | | | | | |
| (A1) PFA | 100 | 100 | 100 | 100 | | 100 | 100 |
| (A2) Modified PTFE | | | | | 100 | | |
| (B) | | | | | | | |
| (B1) CNT150 | 0.1 | 0.05 | | | 0.1 | | |
| (B2) CNT400 | | | 0.1 | | | | |
| (B3) CNT90 | | | | 0.1 | | | |
| (B4)′ CNT30 | | | | | | 0.1 | |
| (C) | | | | | | | |
| (C1) Carbon black | | | | | | | 8 |
| Welding material | | | | | | | |
| CNT average fiber length | 110 | 110 | 300 | 60 | 110 | 20 | — |
| Conductivity | A | B | A | A | A | D | B |
| Volume resistivity | 10² | 10⁴ | 10² | 10² | 10¹ | D | 10⁵ |
| Contamination resistance | | | | | | | |
| Metal | A | A | A | A | A | A | D |
| Carbon | B | B | B | B | B | B | D |
| Weldability | A | A | A | A | A | A | D |

### INDUSTRIAL APPLICABILITY

The present invention provides a novel welding material made of a fluororesin composition in which carbon nano tubes are dispersed in a fluororesin, wherein the fluororesin composition includes 0.01 to 2.0% by mass of the carbon nano tubes.

The welding material has excellent antistatic properties and exhibits excellent welding strength while preventing elution of impurities (metal ions, organic substances, etc.). Therefore, it can be suitably used in a bonding part (for example, a nozzle, a shower head, a spray nozzle, a rotating nozzle, a rotating washing nozzle, a liquid discharge part, a piping member, a liquid (chemical liquid) transfer tube, a liquid transfer joint, a lining piping, a lining tank and the like) through which a liquid passes in fluid treatment apparatuses such as a semiconductor manufacturing apparatus, a pharmaceutical manufacturing apparatus and a chemical manufacturing apparatus.

### RELATED APPLICATION

This application claims priority under Article 4 of Paris Convention based on Japanese Patent Application No. 2018-021654 filed on Feb. 9, 2018 in Japan, which is incorporated by reference in its entirety.

### DESCRIPTION OF REFERENCE NUMERALS

1 Outer tank can
2 Lining layer
3 Liquid introduction pipe
4 Liquid outflow pipe
8 Lining sheet
9 Tank bottom
10 Lining sheet
11 Ground wire (or Earth wire)
13 Ground wire
a Seam (or Bonding part)
14 Lid
15 Lining layer
16 Lining layer
29 Welding material
30 Specimen
31 Groove
32 Lower chuck
33 Upper chuck

1. A welding material made of a fluororesin composition in which carbon nano tubes are dispersed in a fluororesin, wherein the fluororesin composition comprises 0.01 to 2.0% by mass of the carbon nano tubes.

2. The welding material according to claim 1, wherein the carbon nano tubes have an average length of 50 μm or more.

3. The welding material according to claim 1, which has a volume resistivity of 1×10⁻¹ to 1×10⁸ Ω·cm.

4. The welding material according to claim 1, wherein the fluororesin comprises at least one selected from polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), ethylene/chlorotrifluoroethylene copolymer (ECTFE), polychlorotrifluoroethylene (PCTFE), polyvinylidene fluoride (PVDF) and polyvinyl fluoride (PVF).

5. The welding material according to claim 1, wherein the fluororesin in the fluororesin composition has an average particle size of 500 μm or less.

6. The welding material according to claim 1, which is used in a bonding part between a fluororesin and a fluororesin.

7. A fluid treatment apparatus comprising the welding material according to claim 1 in a bonding part between a fluororesin and a fluororesin.

8. A semiconductor manufacturing apparatus, a pharmaceutical manufacturing apparatus, a pharmaceutical delivery apparatus, a chemical manufacturing apparatus or a chemical delivery apparatus, each comprising the fluid treatment apparatus according to claim 7.

9. A method for producing the welding material according to claim 1, the method comprising:
compression-molding a fluororesin composition in which carbon nano tubes are dispersed in a fluororesin.

10. A method for producing the welding material according to claim 1, the method comprising:
preparing a fluororesin composition in which carbon nano tubes are dispersed in a fluororesin selected from PTFE and modified PTFE;
placing the fluororesin composition in a mold, pressurizing and compressing the fluororesin composition to produce a pre-molded body;
calcining the pre-molded body at a temperature equal to or higher than a melting point of the fluororesin composition to produce a molded body; and
processing the molded body to produce a welding material.

11. A method for producing the welding material according to claim 1, the method comprising:
preparing a fluororesin composition in which carbon nano tubes are dispersed in a fluororesin other than PTFE and modified PTFE;
heating the fluororesin composition, pressurizing and compressing the fluororesin composition to obtain a molded body; and
processing the molded body to obtain a welding material.
